(19) United States
(12) Patent Application Publication
(10) Pub. No.: US 2026/0057609 A1
(43) Pub. Date: Feb. 26, 2026

(54) GENERATION OF THREE-DIMENSIONAL MODEL FROM TWO-DIMENSIONAL IMAGE AT ARBITRARY ANGLE

(71) Applicant: Dell Products L.P., Round Rock, TX (US)

(72) Inventors: Junyi Wu, Shanghai (CN); Zijia Wang, London (GB); Tianlu Fei, Shanghai (CN); Zhenzhen Lin, Shanghai (CN); Bin He, Shanghai (CN)

(21) Appl. No.: 18/811,910

(22) Filed: Aug. 22, 2024

(51) Int. Cl. G06T 17/00; G06T 5/70

(52) U.S. Cl. CPC G06T 17/00; G06T 5/70

(57) ABSTRACT

An apparatus comprises at least one processing device that includes a processor coupled to a memory. The processing device is configured to obtain a two-dimensional (2D) off-angle image of at least one object, to transform the 2D off-angle image into a 2D frontal image of the at least one object, to refine the 2D frontal image to generate a refined 2D frontal image, to apply a three-dimensional (3D) reconstruction process to the refined 2D frontal image to generate a 3D model, and to refine the 3D model to generate a refined 3D model. In some embodiments, the 2D off-angle image is transformed utilizing a stable diffusion process comprising one or more latent diffusion models, and the 3D reconstruction process comprises a 3D Gaussian Splatting (3DGS) technique that generates the 3D model by projecting 2D image data of the refined 2D frontal image onto a 3D image plane utilizing 3D Gaussians.

### BACKGROUND

Three-dimensional (3D) models are coming into increasingly widespread use, in a variety of different applications. For example, such 3D models may be used to generate different user-selected views of products in an online shopping application. Unfortunately, conventional techniques for generating 3D models are deficient in various respects. For example, these techniques can be unduly restrictive in terms of the number and type of input images that are required in order to generate the 3D model, and the resulting 3D models often fail to meet desired standards of output image quality.

### SUMMARY

Illustrative embodiments of the present disclosure provide techniques for generation of a 3D model from a single input 2D image, where the input 2D image can be at any arbitrary angle. For example, the input 2D image need not be a frontal image of an object or an image of the object at a particular predetermined angle, such as a 45° angle or a 90° angle. Instead, the input 2D image is illustratively what is more generally referred to herein as an “off-angle image,” where the angle in that term as broadly used herein may be measured with respect to a corresponding frontal image and can take on any arbitrary value, and generally encompasses any non-frontal image with respect to a primary object of that image. Moreover, illustrative embodiments disclosed herein not only avoid the excessive input image restrictions of conventional approaches, but also produce 3D models that exhibit substantially improved output image quality relative to these conventional approaches.

In one embodiment, an apparatus comprises at least one processing device that includes a processor coupled to a memory. The processing device is configured to obtain a 2D off-angle image of at least one object, to transform the 2D off-angle image into a 2D frontal image of the at least one object, to refine the 2D frontal image to generate a refined 2D frontal image, to apply a 3D reconstruction process to the refined 2D frontal image to generate a 3D model, and to refine the 3D model to generate a refined 3D model.

In some embodiments, the 2D off-angle image is transformed into the 2D frontal image utilizing a stable diffusion process that includes one or more latent diffusion models. Other 2D diffusion processes implementing other types of diffusion models can be used in other embodiments.

Additionally or alternatively, the 3D reconstruction process in some embodiments comprises a 3D Gaussian Splatting (3DGS) technique that generates the 3D model by projecting 2D image data of the refined 2D frontal image onto a 3D image plane utilizing 3D Gaussians. Other types of 3D reconstruction processes can be used in other embodiments.

These and other illustrative embodiments disclosed herein include, without limitation, methods, apparatus, systems and computer program products comprising processor-readable storage media.

### BRIEF DESCRIPTION OF THE DRAWINGS

FIG. 1 is a block diagram of an information processing system configured for machine learning-based generation of a 3D model from a single 2D off-angle image in an illustrative embodiment.

FIG. 2 is a flow diagram of an example process for machine learning-based generation of a 3D model from a single 2D off-angle image in an illustrative embodiment.

FIG. 3 shows an example multi-stage pipeline for machine learning-based generation of a 3D model from a single 2D off-angle image in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other cloud-based system that includes one or more clouds hosting multiple tenants that share cloud resources, as well as other types of systems comprising a combination of cloud and edge infrastructure. Numerous different types of enterprise computing and storage systems are also encompassed by the term “information processing system” as that term is broadly used herein.

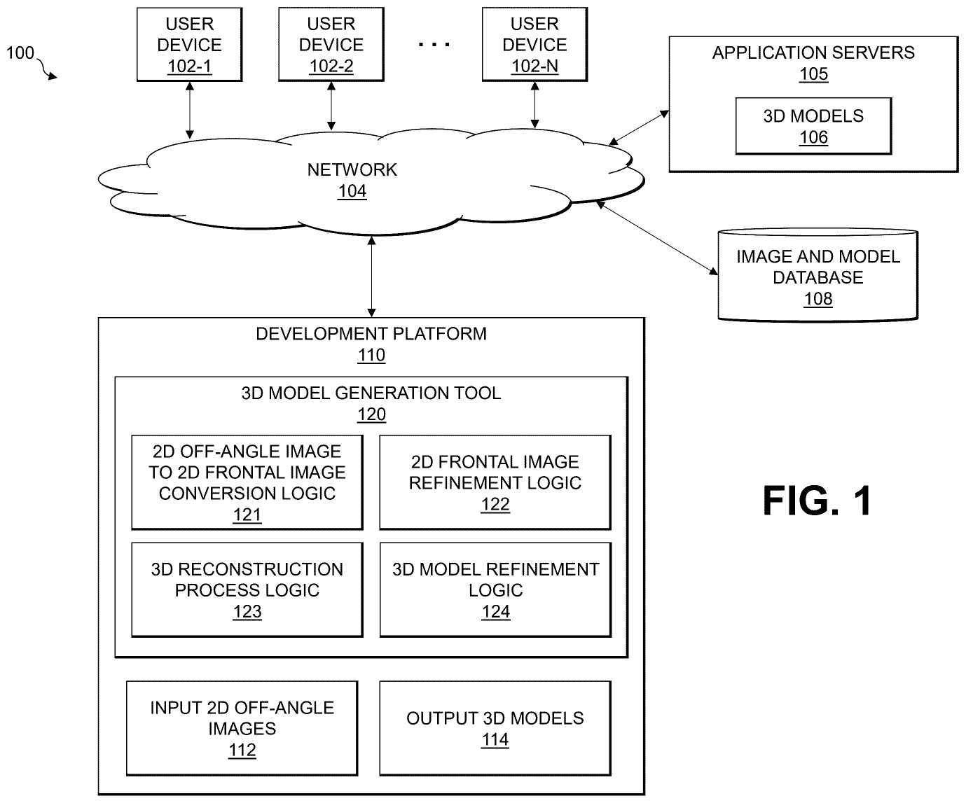

FIG. 1 shows an information processing system 100 configured in accordance with an illustrative embodiment. The information processing system 100 is assumed to be implemented utilizing at least one processing platform comprising one or more processing devices, each including at least one processor coupled to at least one memory, and is configured with functionality for machine learning-based generation of a 3D model from an input 2D image as disclosed herein. The information processing system 100 includes a set of user devices 102-1, 102-2, . . . 102-N, collectively referred to as user devices 102, each of which is coupled to a network 104.

The information processing system 100 additionally comprises a set of one or more application servers 105, with each of the one or more application servers including one or more 3D models 106, and an image and model database 108. These components of the system 100 are each coupled to the network 104.

The information processing system 100 further comprises a development platform 110, which is also coupled to the network 104. The development platform 110 is illustratively configured to process as inputs a set of input 2D off-angle images 112 and to generate as its outputs respective corresponding output 3D models 114. At least a subset of the 3D models 106 deployed to the application servers 105 illustratively include one or more of the output 3D models 114 that are generated in the development platform 110 from the input 2D off-angle images 112 in the manner disclosed herein.

The development platform 110 in this embodiment further comprises a 3D model generation tool 120 that includes 2D off-angle image to 2D frontal image conversion logic 121, 2D frontal image refinement logic 122, 3D reconstruction process logic 123, and 3D model refinement logic 124. These logic components collectively implement a multi-stage pipeline for generating the output 3D models 114 from respective ones of the input 2D off-angle images 112, as disclosed herein. At least a portion of the input 2D off-angle images 112 are obtained by the development platform 110 from the image and model database 108 over the network 104, and at least a portion of the output 3D models 114 are delivered from the development platform 110 to the image and model database 108 over the network 104, illustratively for subsequent deployment to one or more of the application servers 105. In other embodiments, the application servers 105 and/or the image and model database 108 may be implemented on a common processing platform with the development platform 110.

In some embodiments, the 3D model generation tool 120 is configured to generate a given one of the output 3D models from a corresponding single one of the input 2D off-angle images 112, where the corresponding input 2D off-angle image can be at any arbitrary angle. For example, the input 2D off-angle image need not be a frontal image or an image at a particular predetermined angle, such as a 45° angle or a 90° angle. Instead, the input 2D off-angle image is illustratively what is more generally referred to herein as an “off-angle image,” where the angle in that term as broadly used herein may be measured with respect to a corresponding frontal image and can take on any arbitrary value. An “off-angle image” therefore encompasses, for example, any non-frontal image with respect to a primary object of that image, from which a corresponding frontal image can be generated as disclosed herein.

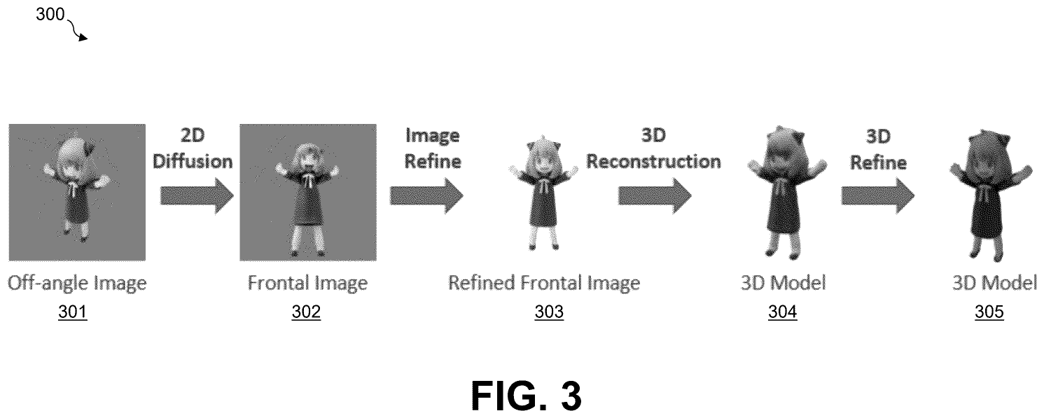

An example multi-stage pipeline that may be implemented using the logic components 121, 122, 123 and 124 of the 3D model generation tool 120 will be described in more detail below in conjunction with FIG. 3. Such logic components are illustratively implemented at least in part in the form of software that executes on at least one processing device utilizing at least one processor and at least one memory thereof, to collectively perform example 3D model generation algorithms as disclosed herein. Accordingly, one or more of the logic components 121, 122, 123 and 124 may be implemented at least in part in the form of software that is stored in memory and executed by a processor.

In operation, the 3D model generation tool 120 is illustratively configured to obtain a particular 2D off-angle image of at least one object, from the input 2D off-angle images 112, to transform the 2D off-angle image in conversion logic 121 into a 2D frontal image of the at least one object, to refine the 2D frontal image in 2D frontal image refinement logic 122 to generate a refined 2D frontal image, to apply a 3D reconstruction process in the 3D reconstruction process logic 123 to the refined 2D frontal image to generate a 3D model, and to refine the 3D model in 3D model refinement logic 124 to generate a refined 3D model. The refined 3D model represents a particular one of the output 3D models 114 corresponding to the particular one of the input 2D off-angle images 112.

The refined 3D model in some embodiments is generated in its entirety in the 3D model generation tool 120 from a single input image comprising the refined 2D frontal image, although other arrangements are possible.

The at least one object of the particular 2D off-angle image in some embodiments comprises a human, although the term “object” as used herein is intended to be broadly construed so as to encompass, for example, humans, animals, inanimate objects or other types of objects, as well as combinations thereof. A given 2D off-angle image in some embodiments may comprise a primary object and one or more secondary objects, with the off-angle aspect of the image being with respect to at least the primary object.

In some embodiments, the 2D off-angle image is transformed in conversion logic 121 into the 2D frontal image utilizing a stable diffusion process that includes one or more latent diffusion models. Other 2D diffusion processes implementing other types of diffusion models can be used in other embodiments.

In one or more such embodiments, refining the 2D frontal image in 2D frontal image refinement logic 122 to generate the refined 2D frontal image illustratively comprises removing at least a portion of an amount of noise introduced by the one or more latent diffusion models of the above-noted stable diffusion process. Other refinement techniques can be used in other embodiments.

As a more particular example, in some embodiments, transforming the 2D off-angle image in conversion logic 121 into the 2D frontal image of the at least one object comprises applying an image transformation of the form \hat{x}=ƒ(x,T) to the 2D off-angle image, where ƒ denotes a first transformation function in accordance with at least one latent diffusion model, x denotes the 2D off-angle image, \hat{x} denotes the 2D frontal image, and T denotes a transformation angle indicative of an angle between the 2D off-angle image and the 2D frontal image.

The term “angle” in this context and others herein is intended to be broadly construed, so as to encompass, for example, various arrangements of one or more angles, such as a rotation angle or other angle measured relative to a reference plane, or a combination of multiple angles measured relative to respective reference planes, such as a horizontal plane and a vertical plane. These and numerous other angular measurements are intended to be encompassed by the term “angle” as broadly used herein, and the term should therefore not be viewed as limited to particular types of rotation angles relative to an angle of a frontal image.

Also by way of example only, refining the 2D frontal image in 2D frontal image refinement logic 122 to generate the refined 2D frontal image in one or more such embodiments illustratively comprises applying a second transformation function to the 2D frontal image to adjust one or more inconsistent features in the 2D frontal image, the second transformation function being different than the first transformation function.

Additionally or alternatively, the 3D reconstruction process implemented in 3D reconstruction process logic 123 in some embodiments comprises a 3D Gaussian Splatting (3DGS) technique that generates the 3D model by projecting 2D image data of the refined 2D frontal image onto a 3D image plane utilizing 3D Gaussians. Other types of 3D reconstruction processes can be used in other embodiments.

In some embodiments, refining the 3D model in 3D model refinement logic 124 to generate the refined 3D model illustratively comprises refining the 3D model based at least in part on one or more features of at least one of the 2D off-angle image and the 2D frontal image.

As indicated previously, in some embodiments one or more of the output 3D models 114 are generated in the model generation tool 120 of the development platform 110 and then deployed into at least one of the application servers 105 that is separate from the development platform 110. Additionally or alternatively, one or more of the output 3D models 114 may be made accessible to one or more users directly on the development platform 110 and/or via controlled access to the image and model database 108.

The user devices 102 of system 100 are illustratively implemented as respective computers or other types and arrangements of processing devices. Such processing devices can include, for example, desktop computers, laptop computers, tablet computers, mobile telephones, Internet of Things (IoT) devices, or other types of processing devices, as well as combinations of multiple such devices. One or more of the user devices 102 can additionally or alternatively comprise virtualized computing resources, such as virtual machines (VMs), containers, etc. The user devices 102 illustratively allow users of the system 100 access to one or more of the 3D models 106 of the application servers 105 via the network 104. One or more of the user devices 102 may additionally or alternatively have access to the development platform 110, for example, to provide one or more of the input 2D off-angle images 112 and to direct the generation of one or more corresponding output 3D models 114.

The term “user” herein is intended to be broadly construed so as to encompass numerous arrangements of human, hardware, software or firmware entities, as well as combinations of such entities.

The network 104 is assumed to comprise a global computer network such as the Internet, although other types of networks can be part of the network 104, including a wide area network (WAN), a local area network (LAN), a satellite network, a telephone or cable network, a cellular network such as 4G or 5G network, a wireless network such as a WiFi or WiMAX network, or various portions or combinations of these and other types of networks. The system 100 in some embodiments therefore comprises combinations of multiple different types of networks. Such networks can support inter-device communications utilizing Internet Protocol (IP) and/or a wide variety of other communication protocols.

The image and model database 108 may be implemented utilizing one or more storage systems associated with one or more processing platforms. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

The system 100 comprising the user devices 102, the application servers 105, the image and model database 108 and the development platform 110 is an example of what is more generally referred to herein as an “information processing system.” Other examples of information processing systems are described elsewhere herein, and the term is intended to be broadly construed to encompass, for example, various arrangements of one or more processing devices, with each such processing device comprising at least one processor and at least one memory coupled to the at least one processor.

The user devices 102 in some embodiments comprise respective computers associated with a particular company, organization or other enterprise. Thus, the user devices 102 may be considered examples of assets of an enterprise system. In addition, at least portions of the information processing system 100 may also be referred to herein as collectively comprising one or more “enterprises.”

In some embodiments, the development platform 110 is used to generate 3D models for an enterprise. For example, an enterprise may subscribe to or otherwise utilize the development platform 110 for generation of 3D models for use in applications such as online shopping, customer service, digital content creation, product development, marketing and sales, customization and personalization, training and simulation, scene reconstruction in laboratory environments. Numerous other operating scenarios involving a wide variety of different types and arrangements of applications and associated processing devices are possible, as will be appreciated by those skilled in the art.

The development platform 110 and/or other portions of the information processing system 100 may be implemented at least in part in cloud infrastructure. For example, the development platform 110 may be provided as a cloud service that is accessible by one or more of the user devices 102 to allow users thereof to manage generation of 3D models based on input 2D images. In some embodiments, at least a portion of the user devices 102 are assumed to be associated with respective users of an enterprise, organization or other entity that seeks to generate and utilize 3D models generated from 2D images. Additionally or alternatively, in some embodiments, at least a portion of the user devices 102 are utilized by members of the same enterprise, organization or other entity that operates the development platform 110. In other embodiments, the user devices 102 are utilized by members of one or more enterprises, organizations or other entities different than the enterprise, organization or other entity that operates the development platform 110 (e.g., a first enterprise provides support functionality for multiple different customers, businesses, etc.). Numerous other examples are possible.

It is to be appreciated that the particular arrangement of the user devices 102, the application servers 105, the image and model database 108 and the development platform 110 illustrated in the FIG. 1 embodiment is presented by way of example only, and alternative arrangements can be used in other embodiments.

The development platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

For example, the development platform 110 is assumed to be implemented using at least one processing device. Each such processing device generally comprises at least one processor and an associated memory, and implements one or more functional modules or logic for controlling certain features of the development platform 110. In the FIG. 1 embodiment, the development platform 110 implements the 3D model generation tool 120 comprising the logic components 121, 122, 123 and 124.

Different portions of the system 100, such as the user devices 102, the application servers 105, the image and model database 108 and the development platform 110, can be implemented on respective distinct processing platforms. Alternatively, the system 100 can be implemented on a single processing platform.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the user devices 102, the application servers 105, the image and model database 108 and the development platform 110, or portions or components thereof, to reside in different data centers. Numerous other distributed implementations are possible. The development platform 110 can also be implemented in a distributed manner across multiple data centers.

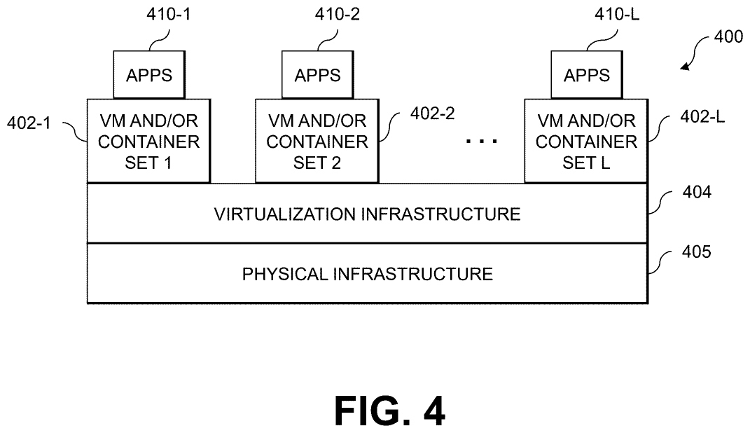

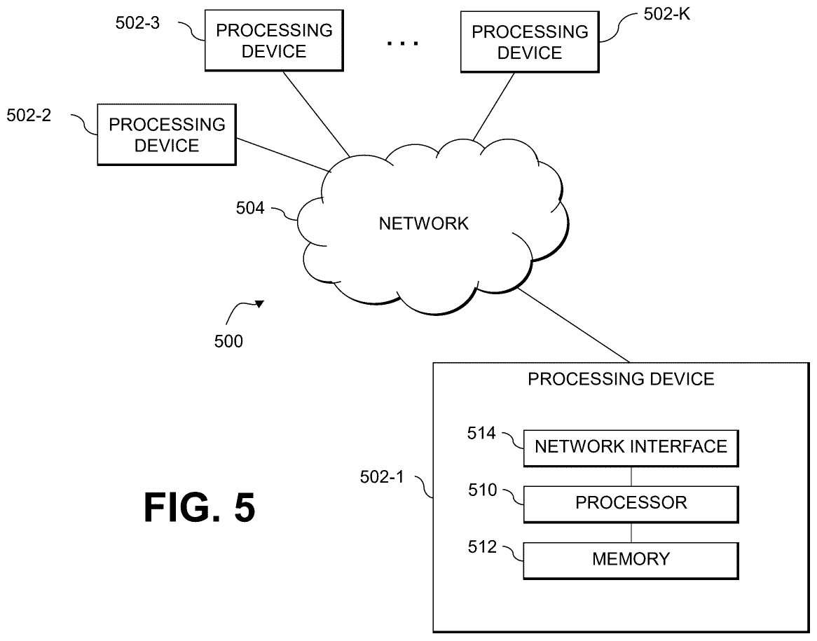

Additional examples of processing platforms utilized to implement the development platform 110 and other components of the information processing system 100 in illustrative embodiments will be described in more detail below in conjunction with FIGS. 4 and 5.

It is to be understood that the particular set of elements shown in FIG. 1 for machine learning-based generation of 3D models is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

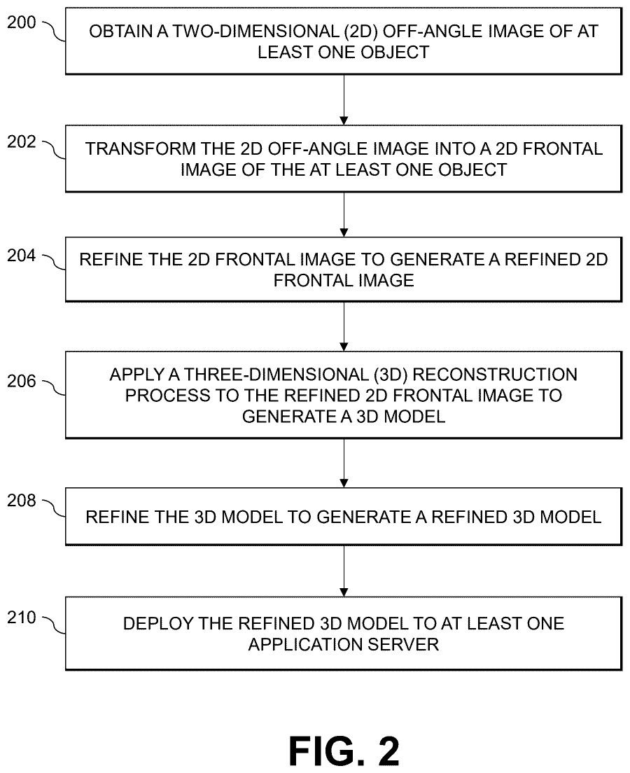

An exemplary process for machine learning-based generation of 3D models will now be described in more detail with reference to the flow diagram of FIG. 2. It is to be understood that this particular process is only an example, and that additional or alternative processes for machine learning-based generation of 3D models may be used in other embodiments.

In this embodiment, the process includes steps 200 through 210. These steps are assumed to be performed by the development platform 110 of system 100 utilizing the 3D model generation tool 120 and its associated logic components, including 2D off-angle image to 2D frontal image conversion logic 121, 2D frontal image refinement logic 122, 3D reconstruction process logic 123, and 3D model refinement logic 124. More particularly, these steps represent an algorithm collectively implemented by the logic components 121, 122, 123 and 124 of the 3D model generation tool 120.

In step 200, a 2D off-angle image of at least one object is obtained, illustratively from the set of input 2D off-angle images 112. For example, a user associated with one of the user devices 102 may upload the 2D off-angle image to the development platform 110 over the network 104 for inclusion in the input 2D off-angle images 112, and/or may select a particular image from the input 2D off-angle images 112.

In step 202, the 2D off-angle image provided and/or selected by the user is transformed into a 2D frontal image of the at least one object. For example, in some embodiments, the 2D off-angle image may be transformed in conversion logic 121 into the 2D frontal image utilizing a stable diffusion process that includes one or more latent diffusion models, although other 2D diffusion processes implementing other types of diffusion models can be used in other embodiments.

In step 204, the 2D frontal image is refined to generate a refined 2D frontal image. This refinement in some embodiments more particularly comprises removing at least a portion of an amount of noise introduced by the one or more latent diffusion models of the above-noted stable diffusion process, although other refinement techniques can be used in other embodiments. As a more particular example, a denoising diffusion probabilistic model may be used in some embodiments, in which a noise-reduction process is applied to the 2D frontal image by predicting noise added at each of multiple timesteps based at least in part on an output of the latent diffusion model, and removing the predicted noise from the 2D frontal image to generate the refined 2D frontal image.

In step 206, a 3D reconstruction process is applied to the refined frontal image to generate a 3D model. For example, in some embodiments, the 3D reconstruction process comprises a 3DGS technique, illustratively implemented by 3D reconstruction process logic 123, that generates the 3D model by projecting 2D image data of the refined 2D frontal image onto a 3D image plane utilizing 3D Gaussians, although other types of 3D reconstruction processes can be used in other embodiments.

In step 208, the 3D model is refined to generate a refined 3D model. For example, in some embodiments, the 3D model refinement logic 124 is configured to generate the refined 3D model based at least in part on one or more features of at least one of the 2D off-angle image and the 2D frontal image.

In step 210, the refined 3D model, which illustratively represents a particular one of the output 3D models 114 of the development platform 110, is deployed to at least one application server, such as one of the application servers 105, for use in one or more applications hosted by the application servers 105, where such applications are accessed by one or more of the user devices 102 over the network 104.

The particular processing operations and other system functionality described in conjunction with the flow diagram of FIG. 2 are presented by way of illustrative example only, and should not be construed as limiting the scope of the disclosure in any way. Alternative embodiments can utilize other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Additional aspects of illustrative embodiments will be described below with reference to the multi-stage pipeline of FIG. 3.

As indicated previously, conventional techniques for generating 3D models are deficient in various respects. For example, these techniques can be unduly restrictive in terms of the number and type of input images that are required in order to generate the 3D model, and the resulting 3D models often fail to meet desired standards of output image quality. As a more detailed example, conventional approaches that attempt to reconstruct a 3D model from a 90° non-frontal 2D image typically experience significant blurring and other undesirable artifacts, leading to substantially diminished image quality.

Illustrative embodiments disclosed herein overcome these drawbacks of conventional techniques. For example, some embodiments not only avoid the excessive input image restrictions of conventional approaches, but also produce 3D models that exhibit substantially improved output image quality relative to these conventional approaches, without the above-noted blurring and other undesirable artifacts.

FIG. 3 shows an example multi-stage pipeline 300 for machine learning-based generation of a 3D model from a single 2D off-angle image in an illustrative embodiment. The multi-stage pipeline 300 in this example comprises four distinct stages, namely, a 2D diffusion stage that converts a 2D off-angle image 301 into a 2D frontal image 302, an image refinement stage that refines the 2D frontal image 302 to generate a refined 2D frontal image 303, a 3D reconstruction stage that processes the refined 2D frontal image 303 to generate a 3D model 304, and a 3D model refinement stage that refines the 3D model 304 to generate a refined 3D model 305. Each of these four stages is described in further detail below. It is to be appreciated, however, that this particular four-stage pipeline is presented by way of illustrative example only, and additional or alternative stages can be used in other embodiments. For example, other embodiments can modify or replace one or more of the refinement stages.

### Stage 1: Transformation of Off-Angle Image to Frontal Image

In the first stage of the example four-stage pipeline, the 2D off-angle image 301 is transformed into the 2D frontal image 302. This stage illustratively utilizes one or more machine learning models, more particularly denoted herein as a transformation function ƒ, which takes a non-frontal image as its input and synthesizes as its output a corresponding frontal image under the transformation, where \hat{x} is the synthesized frontal image, x is the input non-frontal image, and T is the transformation angle:

$$\hat{x} = f ( x , T )$$

This transformation function in illustrative embodiments utilizes a stable diffusion process comprising one or more latent diffusion models, such as a stable diffusion model. Other large diffusion models, or more generally other types of machine learning models, can additionally or alternatively be used.

Latent diffusion models such as the above-noted stable diffusion model generally exhibit exceptional one-shot learning capabilities and also excel in addressing under-constrained tasks by generating plausible and diverse visual outputs. Such latent diffusion models are therefore particularly well-suited for utilization in illustrative embodiments disclosed herein. For example, this disclosed utilization of 2D diffusion techniques to generate the 2D frontal image 302 from the 2D off-angle image 301 strategically enhances the image information available for use in subsequent 3D reconstruction.

Additional details regarding example stable diffusion techniques and associated latent diffusion models that may be implemented in illustrative embodiments herein can be found, for example, in R. Rombach et al., “High-resolution image synthesis with latent diffusion models,” Proceedings of the IEEE/CVF Conference on Computer Vision and Pattern Recognition, pp. 10684-10695, 2022; R. Liu et al., “Zero-1-to-3: Zero-shot One Image to 3D Object,” arXiv:2303.11328v1, Mar. 20, 2023; and R. Shi et al., “Zero 123++: a Single Image to Consistent Multi-view Diffusion Base Model,” arXiv:2310.15110v1, Oct. 23, 2023, each of which is hereby incorporated by reference herein in its entirety.

### Stage 2: Frontal Image Refinement

In the second stage of the example four-stage pipeline, a second transformation function, illustratively denoted herein as g, is used to enhance and otherwise refine the quality of the 2D frontal image 302. For example, in embodiments in which the object of the 2D off-angle image 301 is a human or a human-like-object, the second transformation function g is configured to rectify inconsistent features observed in the 2D frontal image 302 when provided with a blurred counterpart. The refined 2D frontal image not only addresses inconsistencies but also elevates the overall image quality, resulting in a more detailed representation that proves advantageous for subsequent 3D reconstruction processes. For example, in some embodiments, refining the 2D frontal image to generate the refined 2D frontal image comprises removing at least a portion of an amount of noise introduced by the one or more latent diffusion models of the stable diffusion process.

In some embodiments, a denoising diffusion probabilistic model may be used, in which a noise-reduction process is applied to the 2D frontal image by predicting noise added at each of multiple timesteps based at least in part on an output of the latent diffusion model, and removing the predicted noise from the 2D frontal image to generate the refined 2D frontal image. More particularly, the denoising diffusion probabilistic model iteratively applies a noise-reduction process to the rendered images. This process may be modeled according to:

$${x}_{t - 1} = \sqrt{{α}_{t} - 1} ( \frac{{x}_{t} - \sqrt{1 - {α}_{t}} {ϵ}_{θ} ( {x}_{t} , t )}{\sqrt{{α}_{t}}} ) + \sqrt{1 - {α}_{t - 1}} {ϵ}_{t}$$

where xₜ is the image at timestep t, αₜ is the variance schedule, and ∈_{θ} is the noise prediction model. The refinement process includes inputting the rendered images to the denoising diffusion probabilistic model, using the denoising diffusion probabilistic model to predict the noise added at each timestep, and removing the noise. This process is repeated iteratively, enhancing the image quality and alignment to make the 2D frontal image ready for further processing in the next stage of the pipeline.

### Stage 3: 3D Reconstruction

In the third stage of the example four-stage pipeline, a 3DGS technique is utilized, to encapsulate 3D information through the application of 3D Gaussians, thereby projecting 2D data of the refined 2D frontal image 303 onto a 3D image plane in generating the 3D model 304. Such an arrangement advantageously enhances the precision and effectiveness of the overall 3D generation process.

Additional details regarding 3DGS techniques that may be implemented in illustrative embodiments herein can be found, for example, in J. Tang et al., “DreamGaussian: Generative Gaussian Splatting for Efficient 3D Content Creation,” arXiv:2309.16653v2, Mar. 29, 2024, which is incorporated by reference herein in its entirety.

### Stage 4: 3D Model Refinement

In the fourth stage of the example four-stage pipeline, the 3D model 304, which in some instances may exhibit a somewhat blurred texture, is subject to a refinement process based at least in part on one or more features of at least one of the 2D off-angle image and the 2D frontal image. For example, this refinement process may be configured to reintroduce color features to one or more aspects of the object, so as to better align it with intricate details obtained from the frontal image. This elevates the visual fidelity of the 3D model, ensuring a more realistic and detailed representation, leading to improved output image quality and enhanced performance in numerous applications. For example, this four-stage pipeline provides significant improvements in the quality and fidelity of the reconstructed images generated by the 3D model, while also alleviating excessive restrictions on input image number and type, thereby overcoming the drawbacks of conventional techniques.

A number of experiments performed on illustrative embodiments will now be described. In these experiments, the above-described machine learning models were trained using a curated training dataset of randomly selected online images and images of real-life objects. The training dataset encompassed images at diverse angles, with images meticulously captured from various perspectives in real-world scenarios, ensuring a comprehensive and robust training environment for the models. The trained models were then utilized in the example four-stage pipeline of FIG. 3 with 2D off-angle images as input.

The results were compared with corresponding results for the same 2D off-angle images using two conventional approaches, namely the DreamGaussian approach described in the above-cited J. Tang et al. reference, and another approach, generally known as One-2-3-45, described in and M. Liu et al., “One-2-3-45++: Fast Single Image to 3D Objects with Consistent Multi-View Generation and 3D Diffusion,” Proceedings of the IEEE/CVF Conference on Computer Vision and Pattern Recognition (CVPR), 2024, pp. 10072-10083, and M. Liu et al., “One-2-3-45: Any Single Image to 3D Mesh in 45 Seconds without Per-Shape Optimization,” 37th Conference on Neural Information Processing Systems (NeurIPS 2023), each incorporated by reference herein in its entirety.

The results indicated that the example four-stage pipeline embodiment of FIG. 3 consistently demonstrated superior performance over both the DreamGaussian approach and the One-2-3-45 approach in generating high-quality 3D models when provided with 2D off-angle images as input.

With respect to computational efficiency, the example four-stage pipeline of FIG. 3 achieved a processing time of around 7 minutes to generate refined 3D model 305 from the input 2D off-angle image 301. This was comparable to the processing times of the DreamGaussian approach and the One-2-3-45 approach, which came in at 6 minutes and 5 minutes, respectively, for the same input image.

Accordingly, illustrative embodiments provide a computational efficiency similar to that of the DreamGaussian and One-2-3-45 approaches, but with significantly improved performance over these conventional approaches in terms of the reconstructed image quality of the resulting 3D models. This performance advantage was verified in the above-described experiments for a diverse array of 2D input image examples, achieving improved reconstructed image quality relative to the conventional approaches for approximately 95% of the examples. These results substantiate the effectiveness and robustness of the disclosed arrangements across varied input images.

Illustrative embodiments provide numerous additional advantages over conventional approaches.

For example, some embodiments are particularly well-suited for generating highly accurate 3D models for humans and other human-like objects, thereby providing improved application performance in contexts such as identity recognition from images captured at random angles. Similar improvements are provided in numerous other use cases.

The disclosed techniques not only result in the generation of higher-quality 3D models but also accomplish this without significantly increasing the required computational time. This advancement underscores the efficiency and effectiveness of the disclosed 3D model generation techniques, which illustratively provide valuable technical solutions in single-image-based 3D reconstruction.

Illustrative, non-limiting example use cases of the disclosed arrangements include product development, marketing and sales, customization and personalization, training and simulation, and enterprise solutions, each of which is described in more detail below.

For product development, the technical solutions described herein can transform the way that products (e.g., computing devices or other types of IT assets) are designed and prototyped. By using 3D model generation capabilities, designers can rapidly visualize and iterate on new product concepts in 3D, significantly speeding up the prototype phase and reducing costs associated with physical prototyping.

For marketing and sales, the integration of realistic 3D models generated from respective 2D off-axis images can enhance online and digital marketing strategies. By incorporating these models into digital campaigns and virtual showrooms, an enterprise, organization or other entity can offer customers or other users a more interactive and detailed view of products, potentially increasing engagement and sales.

For customization and personalization, leveraging 3D models and associated 3D scene generation allows for a high degree of product customization, which can provide a unique selling point for an enterprise, organization or other entity as customers or other users thereof could visualize and tailor products to their specifications online before purchase, enhancing customer satisfaction and loyalty.

For training and simulation, advanced rendering and refinement techniques can be used to create realistic training simulations for both internal staff and customer or other user education. This can improve the understanding of complex product features and capabilities, leading to better customer service and more effective use of an enterprise, organization or other entity's products.

For enterprise solutions, in enterprise environments the probability density-based optimization techniques can be utilized to create detailed and scalable 3D models (e.g., of data center setups or other IT infrastructure environments), aiding in planning and visualization of complex solutions.

By implementing the technical solutions described herein in these and other use cases, an enterprise, organization or other entity can enhance its product development and customer or other user interaction while also strengthening market leadership through advanced digital capabilities.

The above use cases are only a few examples, and the disclosed techniques are applicable in numerous other contexts.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based generation of 3D models will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that may be utilized to implement at least a portion of the information processing system 100 in FIG. 1. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 may comprise respective VMs, respective sets of one or more containers, or respective sets of one or more containers running in VMs.

In some implementations of the FIG. 4 embodiment, the VMs/container sets 402 comprise respective VMs implemented using virtualization infrastructure 404 that comprises at least one hypervisor. A hypervisor platform may be used to implement a hypervisor within the virtualization infrastructure 404, where the hypervisor platform has an associated virtual infrastructure management system. The underlying physical machines may comprise one or more distributed processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA), a central processing unit (CPU), a graphics processing unit (GPU), a neural processing unit (NPU), a tensor processing unit (TPU), a video processing unit (VPU) or other type of processing circuitry, as well as portions or combinations of such circuitry elements.

The memory 512 may comprise random access memory (RAM), read-only memory (ROM), flash memory or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based generation of 3D models as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, development platforms, 3D model generation tools, logic components, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to obtain a two-dimensional (2D) off-angle image of at least one object;
to transform the 2D off-angle image into a 2D frontal image of the at least one object;
to refine the 2D frontal image to generate a refined 2D frontal image;
to apply a three-dimensional (3D) reconstruction process to the refined 2D frontal image to generate a 3D model; and
to refine the 3D model to generate a refined 3D model.

2. The apparatus of claim 1 wherein the 3D model is generated in its entirety from a single input image comprising the refined 2D frontal image.

3. The apparatus of claim 1 wherein transforming the 2D off-angle image into the 2D frontal image of the at least one object comprises transforming the 2D off-angle image into the 2D frontal image utilizing a stable diffusion process comprising one or more latent diffusion models.

4. The apparatus of claim 3 wherein refining the 2D frontal image to generate the refined 2D frontal image comprises removing at least a portion of an amount of noise introduced by the one or more latent diffusion models of the stable diffusion process.

5. The apparatus of claim 1 wherein applying the 3D reconstruction process to the refined 2D frontal image to generate the 3D model comprises applying a 3D Gaussian Splatting (3DGS) technique to the refined 2D frontal image to generate the 3D model by projecting 2D image data onto a 3D image plane utilizing 3D Gaussians.

6. The apparatus of claim 1 wherein refining the 3D model to generate the refined 3D model comprises refining the 3D model based at least in part on one or more features of at least one of the 2D off-angle image and the 2D frontal image.

7. The apparatus of claim 1 wherein transforming the 2D off-angle image into the 2D frontal image of the at least one object comprises applying an image transformation of the form \hat{x}=ƒ(x,T) to the 2D off-angle image, where ƒ denotes a first transformation function in accordance with at least one latent diffusion model, x denotes the 2D off-angle image, \hat{x} denotes the 2D frontal image, and T denotes a transformation angle indicative of an angle between the 2D off-angle image and the 2D frontal image.

8. The apparatus of claim 7 wherein refining the 2D frontal image to generate the refined 2D frontal image comprises applying a second transformation function to the 2D frontal image to adjust one or more inconsistent features in the 2D frontal image, the second transformation function being different than the first transformation function.

9. The apparatus of claim 1 wherein the 3D model is generated and refined in a development platform and deployed into at least one application server that is separate from the development platform.

10. The apparatus of claim 1 wherein refining the 2D frontal image to generate the refined 2D frontal image comprises utilizing a denoising diffusion probabilistic model in which a noise-reduction process is applied to the 2D frontal image by predicting noise added at each of multiple timesteps based at least in part on an output of a latent diffusion model, and removing the predicted noise from the 2D frontal image to generate the refined 2D frontal image.

11. A computer program product comprising a non-transitory processor-readable storage medium having stored therein program code of one or more software programs, wherein the program code when executed by at least one processing device causes the at least one processing device:
to obtain a two-dimensional (2D) off-angle image of at least one object;
to transform the 2D off-angle image into a 2D frontal image of the at least one object;
to refine the 2D frontal image to generate a refined 2D frontal image;
to apply a three-dimensional (3D) reconstruction process to the refined 2D frontal image to generate a 3D model; and
to refine the 3D model to generate a refined 3D model.

12. The computer program product of claim 11 wherein transforming the 2D off-angle image into the 2D frontal image of the at least one object comprises transforming the 2D off-angle image into the 2D frontal image utilizing a stable diffusion process comprising one or more latent diffusion models.

13. The computer program product of claim 11 wherein applying the 3D reconstruction process to the refined 2D frontal image to generate the 3D model comprises applying a 3D Gaussian Splatting (3DGS) technique to the refined 2D frontal image to generate the 3D model by projecting 2D image data onto a 3D image plane utilizing 3D Gaussians.

14. The computer program product of claim 11 wherein transforming the 2D off-angle image into the 2D frontal image of the at least one object comprises applying an image transformation of the form \hat{x}=ƒ(x,T) to the 2D off-angle image, where ƒ denotes a first transformation function in accordance with at least one latent diffusion model, x denotes the 2D off-angle image, \hat{x} denotes the 2D frontal image, and T denotes a transformation angle indicative of an angle between the 2D off-angle image and the 2D frontal image.

15. The computer program product of claim 14 wherein refining the 2D frontal image to generate the refined 2D frontal image comprises applying a second transformation function to the 2D frontal image to adjust one or more inconsistent features in the 2D frontal image, the second transformation function being different than the first transformation function.

16. A method comprising:
obtaining a two-dimensional (2D) off-angle image of at least one object;
transforming the 2D off-angle image into a 2D frontal image of the at least one object;
refining the 2D frontal image to generate a refined 2D frontal image;
applying a three-dimensional (3D) reconstruction process to the refined 2D frontal image to generate a 3D model; and
refining the 3D model to generate a refined 3D model;
wherein the method is performed by at least one processing device comprising a processor coupled to a memory.

17. The method of claim 16 wherein transforming the 2D off-angle image into the 2D frontal image of the at least one object comprises transforming the 2D off-angle image into the 2D frontal image utilizing a stable diffusion process comprising one or more latent diffusion models.

18. The method of claim 16 wherein applying the 3D reconstruction process to the refined 2D frontal image to generate the 3D model comprises applying a 3D Gaussian Splatting (3DGS) technique to the refined 2D frontal image to generate the 3D model by projecting 2D image data onto a 3D image plane utilizing 3D Gaussians.

19. The method of claim 16 wherein transforming the 2D off-angle image into the 2D frontal image of the at least one object comprises applying an image transformation of the form \hat{x}=ƒ(x,T) to the 2D off-angle image, where ƒ denotes a first transformation function in accordance with at least one latent diffusion model, x denotes the 2D off-angle image, \hat{x} denotes the 2D frontal image, and T denotes a transformation angle indicative of an angle between the 2D off-angle image and the 2D frontal image.

20. The method of claim 19 wherein refining the 2D frontal image to generate the refined 2D frontal image comprises applying a second transformation function to the 2D frontal image to adjust one or more inconsistent features in the 2D frontal image, the second transformation function being different than the first transformation function.
